(19) United States
(12) Patent Application Publication
(10) Pub. No.: US 2023/0048485 A1
(43) Pub. Date: Feb. 16, 2023

(54) NON-ORGANIC CONTAMINATION REMOVAL AUTOMATION PROCESS

(71) Applicant: Atlas Organics, LLC, Spartanburg, SC (US)

(72) Inventor: Jorge Montezuma, Burlington, NC (US)

(21) Appl. No.: 17/886,106

(22) Filed: Aug. 11, 2022

Related U.S. Application Data
(60) Provisional application No. 63/231,990, filed on Aug. 11, 2021.

(51) Int. Cl. B03B 9/06; B02C 23/08

(52) U.S. Cl. CPC B03B 9/06; B02C 23/08

(57) ABSTRACT

A non-organic contamination removal automated process is provided. The process includes: shredding a feedstock having an organic material with a shredder; screening the feedstock with a screener downstream of the shredder; sorting the feedstock using a robot sorter downstream of the screener to remove objects from the feedstock meeting one or more criteria, the robot sorted utilizing one or more machine-learned models; and grinding the feedstock to a desired composting size.

### CROSS-REFERENCE TO RELATED APPLICATIONS

This application is a non-provisional application claiming the benefit of priority under 35 U.S.C. § 119(e) to U.S. Provisional Application No. 63/231,990, filed Aug. 11, 2021, which is hereby incorporated by reference in its entirety.

### FIELD

The present disclosure relates to a new system and process for removing contaminates from organic waste prior to composting using automation.

### BACKGROUND

Conversion of organic material into compost has traditionally been used as a means for recycling such organic material and reducing overall waste. The inventor of the present disclosure has found, however, that processing contaminated organic material can result in damage to processing equipment, costing additional money to repair or replace such processing equipment and reducing a value of any resulting compost as such compost may have inorganic waste material therein. Accordingly, the inventor of the present disclosure has found that a process and method for reducing an amount of inorganic waste material in the organic material to be processed would be useful in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is diagrammatic view of a pre-composting automated contamination removal system in accordance with an exemplary aspect of the present disclosure.

FIG. 2 is a schematic view of a robot sorter of the exemplary pre-composting automated contamination removal system of FIG. 1 in accordance with an exemplary aspect of the present disclosure.

FIG. 3 is a schematic view of a control system in accordance with an exemplary embodiment of the present disclosure.

FIG. 4 is a diagram of a pre-composting automated contamination removal process in accordance with an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

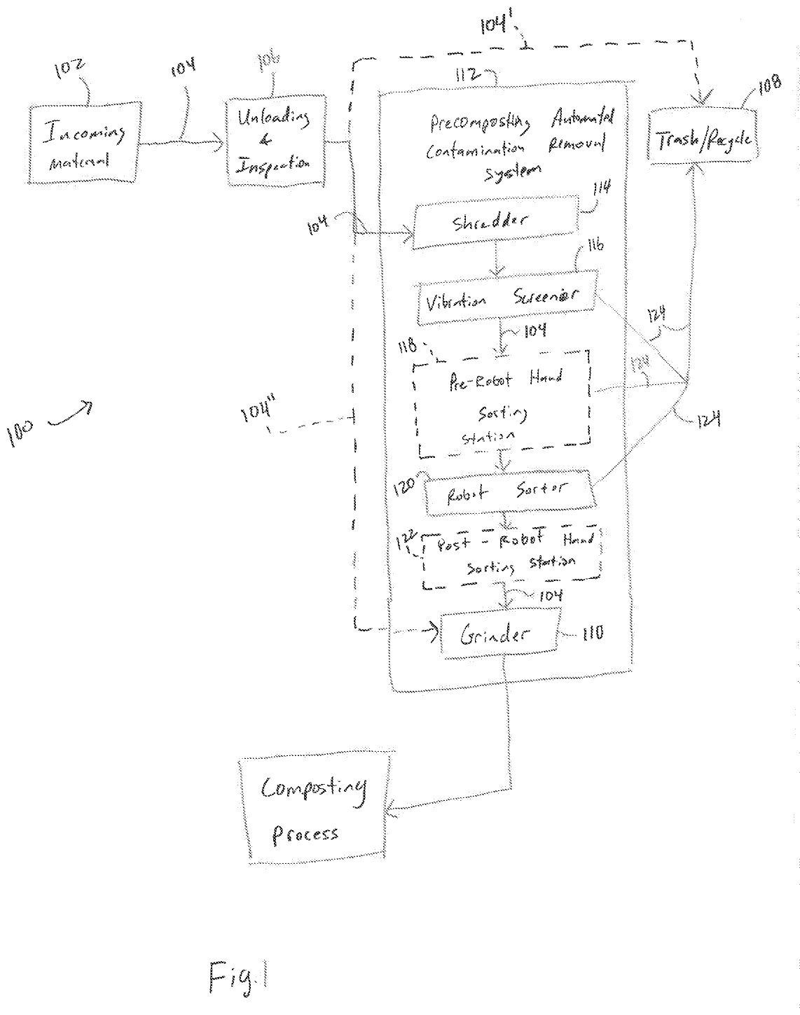

Referring now to the drawings, FIG. 1 is a flow diagram of a composting system 100 in accordance with the present disclosure. The composting system 100 may generally be utilized to process an organic material, or feedstock 104. The “feedstock” may be substantially primarily residential/commercial yard waste (e.g., limbs, bushes, clippings, or the like), post-consumer food waste, etc., or a combination of both.

Feedstock 104 may be received by the composting system 100 as incoming material at 102. The incoming material 102 may be a mix of organic material and non-organic material, herein may be referred to as “contaminated feedstock”.

The feedstock 104 is provided to an unloading and inspection station 106. The unloading and inspection station 106 may provide a high level inspection of the feedstock 104 to determine if it is above an upper predetermined threshold of contamination, below a lower predetermined threshold of contamination, or within a sortable range of contamination (e.g., above the lower predetermined threshold and below the upper predetermined threshold). Optionally, if the feedstock 104 is above the upper predetermined threshold, the system 100 may provide the feedstock directly to a trash/recycle station 108, as depicted at phantom line 104′ in FIG. 1. Additionally, or alternatively, if the feedstock 104 is below the lower predetermined threshold, the system 100 may provide the feedstock 104 directly to a grinding station 110, discussed below, as depicted at phantom line 104″.

It will be appreciated, however, that in other exemplary aspects of the system 100, the system 100 may not include one or both of the processes at 104′ and 104″ noted above with respect to the unloading and inspection station 106.

Referring still to the exemplary system 100 of FIG. 1, the feedstock 104 is provided from the unloading and inspection station 106 to a pre-composing automated contamination removal system (“PACRS”) 112. As will be appreciated from the description herein, within the PACRS depicted in FIG. 1, a sorting process in accordance with an exemplary embodiment of the present disclosure is detailed that involves pre-composting contamination removal from the feedstock 104 by shredding, removal of a fine fraction of material through screening, an optional pre-robot hand sorting, a robot sorting, an optional post-robot hand sorting, and grinding. These steps are discussed in more detail below. Other aspects of the present disclosure may not include all of the above steps, may include additional steps not disclosed herein, or both.

In particular, the PACRS 112 includes a shredder 114. The shredder 114 receives the feedstock 104 and executes an initial shredding step. The shredding step may provide for a reduction in a size of the provided feedstock 104 (which, as noted above, may be a contaminated feedstock), such that following the shredding step, approximately 80% of the feedstock defines a greatest measure that is less than a first length and approximately 20% of the feedstock defines a greatest measure is less than a second length. A “greatest measure” refers to the largest of a length, a width, a diameter, or the like of an individual object within the feedstock 104. The first length may be between about 5 inches and about 30 inches, such as between about 8 inches and about 20 inches, such as between about 10 inches and about 15 inches, such as about 12 inches. The second length may be between about 0.25 inches and about 8 inches, such as between about 0.5 inches and about 5 inches, such as about 1 inch.

Such may reduce a size of the feedstock 104 by the shredder 114 may facilitate the desired downstream screening and sorting, e.g., removal of the non-organic material in the feedstock 104.

The system 100 subsequently includes a screener 116. The screener 116 received the feedstock 104 having a reduced size facilitated by the shredder 114. The screener executes a screening step, such as a trommel screening step. In such a manner, the screener 116 may remove portions of the provided feedstock 104 having a greatest measure that is less than a third length. The third length may be about equal to the second length. Additionally, or alternatively, the third length may be between about 0.15 inches and about 8 inches, such as between about 0.25 inches and about 5 inches, such as between about 0.5 inches and about 2 inches, such as about 1 inch. In such a manner, the screener may be configured to screen out between about 2% by weight of the feedstock 104 provided to the screener 116 and about 25% by weight of the feedstock 104 provided to the screener 116, such as between about 5% and about 20% by weight of the feedstock 104 provided to the screener 116.

Referring still to the exemplary system 100 of FIG. 1, and more specifically to the exemplary PACRS 112 of FIG. 1, the PACRS 112 further includes a pre-robot hand sorting station 118, a robot sorter 120, and a post-robot hand sorting station 122. The pre-robot hand sorting station 118 is positioned upstream of the robot sorter 120 and the post-robot hand sorting station 122 is positioned downstream of the robot sorter 120. The pre-robot hand sorting station 118 and the post-robot hand sorting station 122 are each depicted in phantom in FIG. 1 to indicate that in one exemplary embodiment, the PACRS 112 may only include the pre-robot hand sorting station 118; in another exemplary embodiment, the PACRS 112 may only include the post-robot hand sorting station 122; in another exemplary embodiment, the PACRS 112 may include both the pre-robot hand sorting station 118 and the post-robot hand sorting station 122; and in yet another exemplary embodiment, the PACRS 112 may not include either of the pre-robot hand sorting station 118 or the post-robot hand sorting station 122.

The pre-robot hand sorting station 118 and/or the post-robot hand sorting station 122 may include a position for one or more persons to remove objects from the feedstock 104 outside a desired size range, such as outside a size range bounded on an upper end at about 20 inches, such as about 15 inches, such as about 10 inches, such as about 8 inches, such as about 6 inches, and bound on a lower end at about 0.25 inches, such as about 1 inch, such as about 2 inches. The object removed at one or both of the stations 118, 122 may be provided as waste 124 to the trash/recycle station 108.

Additionally, or alternatively, the pre-robot hand sorting station 118 and/or the post-robot hand sorting station 122 may include a position for one or more persons to remove contaminates from the feedstock 104.

As noted, the system 100, and more specifically the PACRS 112 further includes the robot sorter 120. The robot sorter 120 is configured to sort objects within the feedstock 104 based on one or more provided criteria, such as a maximum weight and size of the objects, the type of object (organic vs. inorganic material), etc. The objects removed by the robot sorter 120 may be provided as waste 124 to the trash/recycle station 108.

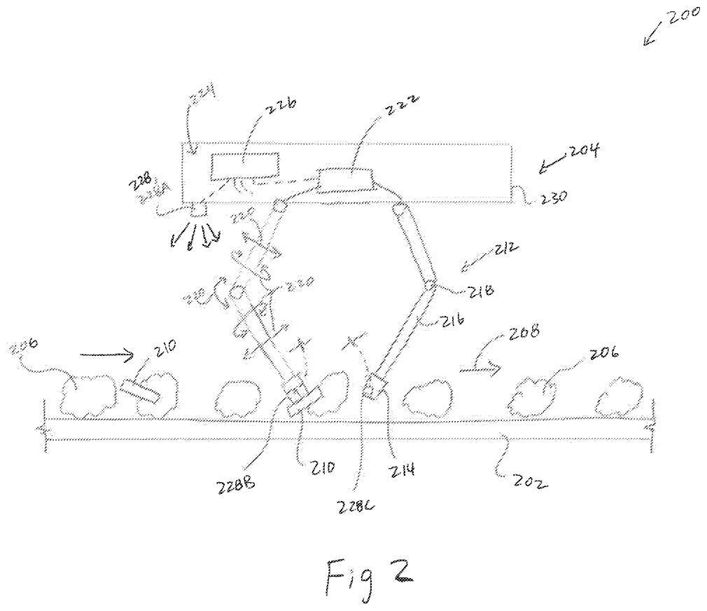

The robot sorter 120 will be described in more detail below with reference to FIG. 2.

Referring still to the PACRS 112 of FIG. 1, the feedstock 104 provided from the robot sorter 120 and optional pre-robot hand sorting station 118 and post-robot hand sorting station 122 may be referred to as a “decontaminated feedstock.”

The decontaminated feedstock 104 is then provided to a grinder 126. At the grinder, the sorted material/decontaminated feedstock 104 may be reduced in size such that at least about 90% by weight of the feedstock 104 from the grinder 126 is within a desired composting size range. The desired composting size range may be a range of about 0.5 inches to about 8 inches, such as between about 1 inch and about 6 inches, such as between about 2 inches and about 4 inches.

The exemplary system 100 of FIG. 1 provides for a unique way to sort the material prior to composting to allow for a desired amount of non-organic object removal (e.g., plastics, metals, etc.), resulting in less damage to the processing equipment (e.g., the grinder 110) and more valuable compost. In particular, providing an initial shredding step with the shredder 114 to reduce a material size of the feedstock 104 while keeping the feedstock 104 sufficiently coarse may allow for a desired amount of non-organic materials to be removed through screening using the screener 116 and sorting at stations 118 and 122 and with robot sorter 120, resulting in higher percentage of organic material provided to the grinder 110, and less contamination in the resulting compost.

Additionally, the process of FIG. 1 may provide for a relatively efficient way to sort the material prior to composting. For example, the system 100 may be capable of processing between about 20 and 100 tons per hour (measured based on the tonnage provided to the shredder 114), such as at least 30 tons per hour, such as at least 40 tons per hour, such as at least 45 tons per hour, such as up to 80 tons per hour.

Referring now to FIG. 2, a schematic view is provided of a robot sorter 200 in accordance with the present disclosure. The robot sorter 200 of FIG. 2 may be incorporated into a PACRS, e.g., as the robot sorter 120 of the PACRS 112 of FIG. 1.

The robot sorter 200 generally includes a conveyor 202 and a robot 204. The conveyor 202 is configured to receive feedstock 206 and move the feedstock 206 in a first direction 208, and the robot 204 is configured to remove objects 210 from the feedstock 206 meeting certain criteria, as will be discussed in more detail below.

For the embodiment depicted, the robot 204 includes one or more robot arms 212, each of the one or more robot arms 212 having a clutch mechanism 214 at a distal end for clutching the objects 210 to be removed from the feedstock 206 during operation of the robot sorter 200. In certain exemplary embodiments, the clutch mechanism 214 may be, e.g., a suction cup, a pincher, a hook, or any other suitable structural feature for removing certain objects 210 from the feedstock 206.

Each of the one or more robot arms 212 includes a plurality of sections 216 joined at one or more joints 218. The plurality of sections 216 may be movable to facilitate the clutch mechanism 214 moving between the feedstock 206 and, e.g., a trash/recycle receptacle (not shown). In particular, in the embodiment depicted, the plurality of sections 216 of the one or more robot arms 212 defines at least 2 degrees of freedom, such as at least 4 degrees of freedom, such as 6 degrees of freedom, as indicated by the arrows 220 depicted in FIG. 2 (arrows 220 are only shown for reference with one of the robot arms 212, but each of the robot arms 212 may have a similar degree of freedom).

Notably, in the embodiment depicted, the one or more robot arms 212 includes two robot arms 212. However, in other exemplary embodiments, the one or more robot arms 212 may include a single robot arm 212, three or more robot arms 212, four or more robot arms 212, and up to, e.g., 20 robot arms 212.

Further, although in the embodiment depicted each of the one or more robot arms 212 is depicted being formed of a relatively small number of individual sections 216 coupled together through joints 218, in other embodiments, the one or more robot arms 212 may instead be formed in any other suitable manner to facilitate the noted degrees of freedom with the clutch mechanism 214.

The robot 204 further includes a motor 222 coupled to the one or more robot arms 212 for driving the one or more robot arms 212 in the various degrees of freedom. The motor 222 may be, e.g., an electrically actuated motor 222.

The motor 222 may also actuate the clutch mechanisms 214. The motor 222 may be a single motor 222 or a plurality of motors 222 (e.g., one motor 222 per robot arm 212) of a same or different type.

Further, still, the exemplary robot 204 depicted includes a control system 224. The control system 224 generally includes a controller 226 and one or more sensors 228. The one or more sensors 228 may include, e.g., one or more optical sensors 228 (e.g., using infrared or other visual identification technologies) to sense data indicative of the feedstock 206, such as data indicative of a size and/or type of objects 210 within the feedstock 206.

In the embodiment depicted, the one or more sensors 228 includes a first sensor 228A mounted to a housing 230, with the housing 230 enclosing at least in part the motor 222 of the robot 204 and the controller 226 of the control system 224. The first sensor 228A is generally oriented towards the conveyor 202 to sense optical data of the feedstock 206. In addition, for the embodiment depicted, the one or more sensors 228 includes a second sensor 228B and a third sensor 228C, with the second and third sensors 228B, 228C positioned on a respective arm 212 of the one or more arms 212 of the robot 204. In particular, for the embodiment depicted, the second third sensors 228B, 228C are positioned at distal ends of the respective arms 212.

The controller 226 is in communication with one or more sensors 228 (such as in a wired or wireless communication) to receive data from the one or more sensors 228, such as optical data of the feedstock 206 on the conveyor 202. From a high level, the controller 226 may be configured to receive the data from the one more sensors 228 and make control decisions in response. The control decisions may be provided to, e.g., the robot 204 to control the robot 204 in order to extract objects 210 from the feedstock 206 meeting certain criteria.

For example, objects 210 within the feedstock 206 over about weight threshold (e.g., 2 pounds, 4 pounds, 6 pounds, 8 pounds, 10 pounds) and objects 210 over a size threshold (e.g., about 6 inches by about 6 inches by about 3 inches) may be identified and selectively picked and removed from the feedstock 206. Additionally, or alternatively, objects 210 that are identified by the robot 204 as being an inorganic material may be selectively picked and removed from the feedstock 206.

The robot 204 may have a false positivity rate of approximately 5% or less, a pick success rate of approximately 90% or greater, and a material identification efficiency rate of approximately 90% or greater.

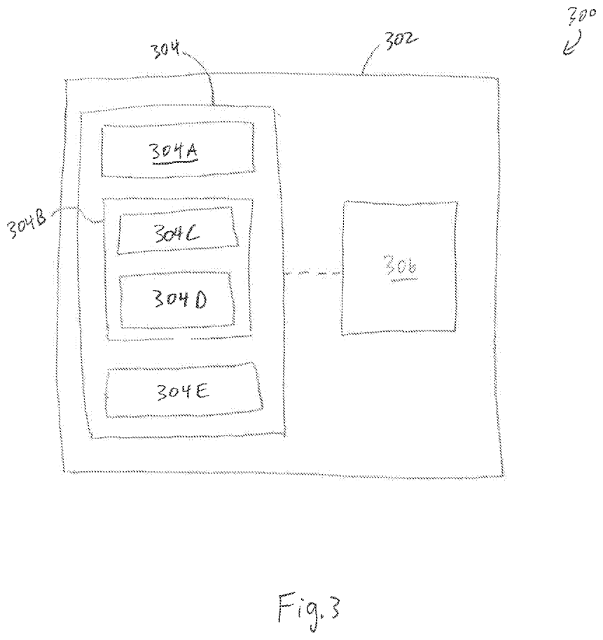

Moreover, the robot 204 may utilize artificial intelligence (e.g., may use machine learning and/or artificial intelligence) to identify and remove objects 210 that meet certain criteria. More specifically, the robot 204 disclosed herein may utilize one or more machine-learned models (also referred to as an artificial intelligence model herein) for detecting one or more objects 210 (e.g., one or more inorganic objects 210 such as metals or plastics) and providing control decisions/commands to the robot 204 to remove the detected one or more objects 210. In particular, as will be appreciated from the discussion below with reference to FIG. 3, the control system 224 of the robot 204 may update the criteria using the artificial intelligence model

It will be appreciated, however, that in other exemplary embodiments, the robot of the robot sorter may be configured in any other suitable manner. For example, in other embodiments, the robot may sort out objects from beneath a plane of the conveyor. For example, in other embodiments, the robot may include an array of fluid jets configured to extract objects as the objects are provided across a gap between adjacent sections of the conveyor. Other configurations are contemplated as well.

Referring now to FIG. 3, a control system 300 of the present disclosure is provided. The control system 224 described above with reference to FIG. 2 may be configured in a similar manner as the exemplary control system of FIG. 3.

The control system 300 is configured to receive the data sensed from one or more sensors (e.g., sensors 228 for the embodiment shown) and, e.g., may make control decisions for the composting system 100 based on the received data.

The control system 300 includes a controller 302. In one or more exemplary embodiments, the controller 302 depicted in FIG. 3 may be a stand-alone controller 302 for the composting system 100 (and, e.g., the robot sorter), or alternatively, may be integrated into one or more of a controller for a system including the composting system 100 and robot sorter.

Referring particularly to the operation of the controller 302, in at least certain embodiments, the controller 302 can include one or more computing device(s) 304. The computing device(s) 304 can include one or more processor(s) 304A and one or more memory device(s) 304B. The one or more processor(s) 304A can include any suitable processing device, such as a microprocessor, microcontroller, integrated circuit, logic device, and/or other suitable processing device. The one or more memory device(s) 304B can include one or more computer-readable media, including, but not limited to, non-transitory computer-readable media, RAM, ROM, hard drives, flash drives, and/or other memory devices.

The one or more memory device(s) 304B can store information accessible by the one or more processor(s) 304A, including computer-readable instructions 304C that can be executed by the one or more processor(s) 304A. The instructions 304C can be any set of instructions that when executed by the one or more processor(s) 304A, cause the one or more processor(s) 304A to perform operations. In some embodiments, the instructions 304C can be executed by the one or more processor(s) 304A to cause the one or more processor(s) 304A to perform operations, such as any of the operations and functions for which the controller 302 and/or the computing device(s) 304 are configured, the operations for operating a composting system 100 (e.g., method 400), as described herein, and/or any other operations or functions of the one or more computing device(s) 304. The instructions 304C can be software written in any suitable programming language or can be implemented in hardware. Additionally, and/or alternatively, the instructions 304C can be executed in logically and/or virtually separate threads on the one or more processor(s) 304A. The one or more memory device(s) 304B can further store data 304D that can be accessed by the one or more processor(s) 304A. For example, the data 304D can include data indicative of power flows, data indicative of engine/aircraft operating conditions, and/or any other data and/or information described herein.

The computing device(s) 304 can also include a network interface 304E used to communicate, for example, with the other components of the composting system 100, the sensors, etc. For example, in the embodiment depicted, as noted above, the composting system 100 includes one or more sensors for sensing data indicative of one or more parameters of the composting system 100. The controller 302 the composting system 100 is operably coupled to the one or more sensors through, e.g., the network interface, such that the controller 302 may receive data indicative of various operating parameters sensed by the one or more sensors during operation. Further, for the embodiment shown the controller 302 is operably coupled to, e.g., motor of the robot of the robot sorter. In such a manner, the controller 302 may be configured to control operation of the robot of the robot sorter in response to, e.g., the data sensed by the one or more sensors.

The network interface 304E can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

In addition, the control system 300, and more specifically the controller 302 includes one or more machine-learned models 306. The one or more machine-learned models 306 may detect the one or more objects based on sensor data generated with the one or more sensors. The sensor data may include image data, mass data, electrical property data, magnetic property data, light data (e.g., infrared data), and/or audio data. The one or more sensors can include image sensors, scales, oscilloscopes, infrared sensors, radar sensors, and/or one or more other sensors.

For example, the one or more machine-learned models 306 may be trained to process one or more images to generate a detection output indicating the presence of and the location of one or more objects of one or more particular object types. The one or more particular object types may be based on a material of the object, the properties of the object (e.g., the density, the electrical properties, and/or the magnetic properties), a shape of the object, and/or the size of the object. In particular, the one or more machine-learned models 306 can receive a continuous flow of input images (e.g., a plurality of images of the feedstock on the conveyor) to process and may generate a detection output when one or more of the input images include an object of the one or more particular object types (e.g., a plastic object, a metal object, and/or another inorganic object).

The one or more machine-learned models 306 can include one or more detection models, one or more segmentation models, and/or one or more classification models. For example, a detection model can process the sensor data and generate one or more bounding boxes indicating features of interest in the sensor data. The segmentation model may segment the sensor data associated with the bounding boxes. The classification model can then process the segmented sensor data to classify the features. For example, an image can be processed by a detection model, which can generate one or more bounding boxes as an output in response to detecting one or more object features. The segmentation model can then isolate a set of pixels associated with the one or more object features based on the one or more bounding boxes. The set of pixels can then be processed to determine a classification for the object in the image.

The one or more machine-learned models 306 may be trained individually and/or in parallel. The training data for the one or more machine-learned models 306 can include training sensor data, ground truth training data (e.g., example inputs paired with one or more of ground truth bounding boxes, ground truth classifications, ground truth segmentation outputs, and/or other ground truth outputs), labeled examples, and/or pre-learned embedding data. Training the one or more machine-learned models 306 can include supervised learning, unsupervised learning, and/or semi-supervised learning. Additionally and/or alternatively, the one or more machine-learned models 306 may be trained with ground truth training, distillation learning, intermediate output comparisons, nearest neighbor comparison, and/or other training techniques, which may include one or more loss functions used individually and/or in combination to generate one or more prompt gradients to be back propagated to the one or more machine-learned models 306 to adjust one or more parameters of the machine-learned model.

In some implementations, the one or more machine-learned models 306 may be trained on user obtained labeled datasets. Alternatively and/or additionally, the one or more machine-learned models 306 may be trained on training data obtained from a database, or online repository.

In some implementations, the one or more machine-learned models 306 may be trained to detect and classify objects of a particular type or composition. Alternatively and/or additionally, the one or more machine-learned models 306 may be trained to detect and classify objects based on the objects differing from one or more particular object types or compositions (e.g., the object is not of a compostable object type or composition).

The object location and classification may be provided as output for the one or more machine-learned models 306 and may be utilized to instruct one or more robotic mechanisms to remove the object from the environment.

In some implementations, one or more other machine-learned models 306 may be utilized for robotic calibration.

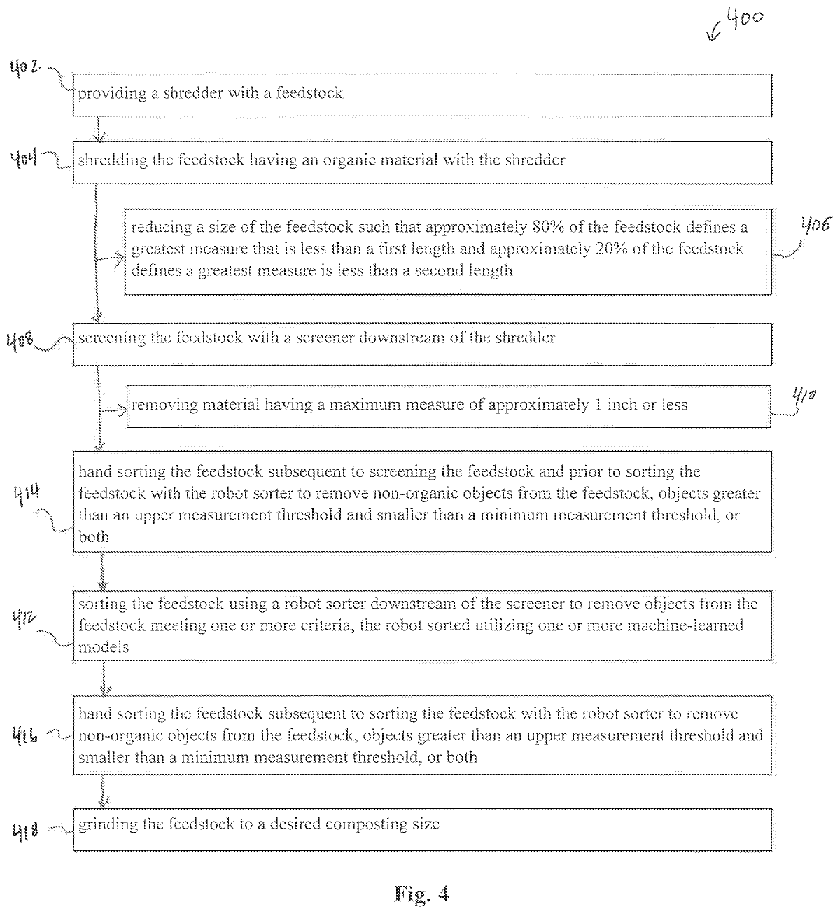

Referring now to FIG. 4, a flow diagram of a non-organic contamination removal automated process 400 is provided. The process of 400 may be utilized with one or more of the exemplary embodiments described above.

The process 400 includes at (402) providing a shredder with a feedstock, and at (404) shredding the feedstock having an organic material with the shredder. In certain exemplary aspects, shredding the feedstock at (404) includes at (406) reducing a size of the feedstock such that approximately 80% of the feedstock defines a greatest measure that is less than a first length and approximately 20% of the feedstock defines a greatest measure is less than a second length. The first length may be between about 8 inches and about 20 inches, and the second length may be between about 0.25 inches and about 8 inches.

The process 400 further includes at (408) screening the feedstock with a screener downstream of the shredder. In certain exemplary aspects, screening the feedstock at (408) includes at (410) removing material having a maximum measure of approximately 1 inch or less.

The process 400 further includes at (412) sorting the feedstock using a robot sorter downstream of the screener to remove objects from the feedstock meeting one or more criteria, the robot sorted utilizing one or more machine-learned models.

For the exemplary aspect of the process 400 depicted, the process 400 optionally includes at (414) hand sorting the feedstock subsequent to screening the feedstock and prior to sorting the feedstock with the robot sorter to remove non-organic objects from the feedstock, objects greater than an upper measurement threshold and smaller than a minimum measurement threshold, or both. Similarly, the process 400 optionally includes at (416) hand sorting the feedstock subsequent to sorting the feedstock with the robot sorter to remove non-organic objects from the feedstock, objects greater than an upper measurement threshold and smaller than a minimum measurement threshold, or both.

Referring still to FIG. 4, the process 400 additionally includes at (418) grinding the feedstock to a desired composting size.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A non-organic contamination removal automated process comprising:
shredding a feedstock comprising an organic material with a shredder;
screening the feedstock with a screener downstream of the shredder;
sorting the feedstock using a robot sorter downstream of the screener to remove objects from the feedstock meeting one or more criteria, the robot sorted utilizing one or more machine-learned models; and
grinding the feedstock to a desired composting size.

2. The process of claim 1, further comprising:
hand sorting the feedstock subsequent to screening the feedstock and prior to sorting the feedstock with the robot sorter to remove non-organic objects from the feedstock, objects greater than an upper measurement threshold and smaller than a minimum measurement threshold, or both.

3. The process of claim 1, further comprising:
hand sorting the feedstock subsequent to sorting the feedstock with the robot sorter to remove non-organic objects from the feedstock, objects greater than an upper measurement threshold and smaller than a minimum measurement threshold, or both.

4. The process of claim 1, wherein the criteria utilized by the robot in sorting the feedstock comprise object size, object weight, object type, or a combination thereof.

5. The process of claim 1, wherein the criteria utilized by the robot in sorting the feedstock comprises object type.

6. The process of claim 1, further comprising:
updating the criteria using the one or more machine-learned models.

7. The process of claim 1, wherein the feedstock comprises an organic waste.

8. The process of claim 1, wherein the feedstock comprises yard waste, post-consumer food waste, or a combination of both.

9. The process of claim 1, further comprising:
providing the shredder with the feedstock, wherein the feedstock provided to the shredder comprises an organic waste and inorganic contaminants, and wherein the objects removed from the feedstock with the robot sorted are the inorganic contaminants.

10. The process of claim 1, wherein shredding a feedstock comprising reducing a size of the feedstock such that approximately 80% of the feedstock defines a greatest measure that is less than a first length and approximately 20% of the feedstock defines a greatest measure is less than a second length, wherein the first length is between about 8 inches and about 20 inches, and wherein the second length is between about 0.25 inches and about 8 inches.

11. The process of claim 1, wherein screening the feedstock comprises removing material having a maximum measure of approximately 1 inch or less.

12. A non-organic contamination removal automated system, the system comprising:
a shredder configured to receive a feedstock comprising an organic material and reduce a size of the feedstock;
a screener positioned downstream of the shredder for receiving the feedstock from the shredder and screening out feedstock smaller than a minimum threshold;
a robot sorter positioned downstream of the screener and comprising a conveyor, a robot, and a control system, the robot comprising one or more robot arms operable to remove objects from the feedstock on the conveyor meeting one or more criteria, the control system operable with the robot to control the robot, the control system utilizing one or more machine-learned models; and
a grinder positioned downstream of the robot sorter for grinding the feedstock to a desired composting size.

13. The system of claim 12, wherein the criteria utilized by the robot in sorting the feedstock comprise object size, object weight, object type, or a combination thereof.

14. The system of claim 12, wherein the criteria utilized by the robot in sorting the feedstock comprises object type.

15. The system of claim 12, wherein the feedstock comprises an organic waste.

16. The system of claim 12, wherein the feedstock comprises yard waste, post-consumer food waste, or a combination of both.

17. The system of claim 12, wherein the shredder is operable to shred the feedstock such that approximately 80% of the feedstock defines a greatest measure that is less than a first length and approximately 20% of the feedstock defines a greatest measure is less than a second length, wherein the first length is between about 8 inches and about 20 inches, and wherein the second length is between about 0.25 inches and about 8 inches.

18. The system of claim 12, wherein the screener is operable to remove material having a maximum measure of approximately 1 inch or less.

19. The system of claim 12, further comprising:
a hand sorting station downstream of the screener and upstream of the robot sorter.

20. The system of claim 12, further comprising:
a hand sorting station downstream of the screener and upstream of the robot sorter.
